(19) United States
(12) Patent Application Publication
(10) Pub. No.: US 2010/0174388 A1
(43) Pub. Date: Jul. 8, 2010

(54) Live Device Graphical Status Tree

(76) Inventors: David A. Ferreira, Hope, RI (US); Peter E. Allstrom, Attleboro, MA (US)

Correspondence Address: Richard L. Sampson;SAMPSON & ASSOCIATES, P.C., 50 Congress Street, Boston, MA, 02109, US

(21) Appl. No.: 12/348,214

(22) Filed: Jan. 2, 2009

(51) Int. Cl. G06F 11/32; G06F 3/048; G05B 15/02

(52) U.S. Cl. 700/83; 715/772; 714/57; 714/E11.188

(57) ABSTRACT

A system and method is provided for storing hierarchical inputs for a field device in a control system, including upper level inputs in the form of data relating to the process under control, received from a plurality of input devices, and lower level inputs generated by the field devices using the upper level inputs. A record of dependencies among the hierarchical inputs is maintained, along with the status of each of the hierarchical inputs, which is transformed into a graphical status tree representation thereof, including the dependencies shown as one or more hierarchical flow paths. The status of the hierarchical inputs in the graphical status tree is identified by applying a visual marker to inputs having a normal status, and applying other visual markers to inputs having an error status to highlight erroneous flow paths.

### BACKGROUND

1. Technical Field

This invention relates to process control systems and, more particularly, to a graphical user interface system for field device diagnostics in a process control system.

2. Background Information

The terms “control” and “control systems” refer to the control of the operational parameters of a device or system by monitoring one or more of its characteristics. This is used to insure that output, processing, quality and/or efficiency remain within desired parameters over the course of time.

Control is used in a number of fields. Process control, for example, is typically employed in the manufacturing sector for process, repetitive and discrete manufacture, though it also has wide application in electric and other service industries. Environmental control finds application in residential, commercial, institutional and industrial settings, where temperature and other environmental factors must be properly maintained. Control is also used to monitor and control devices used in the manufacture of various products, ranging, for example, from toasters to petrochemicals to aircraft.

Control systems typically utilize field devices, including sensors and the like, which are integrated into the equipment being controlled. For example, temperature sensors are usually installed directly on or within the articles, bins, or conduits that process, contain or transport the materials being measured. Control devices such as valves, relays, and the like, must also be integrated with the equipment whose operations they govern.

As the complexity of control systems has increased, it has become increasingly important to enable efficient and accurate identification of faults within the systems.

The I/A SERIES® process control systems, manufactured by the assignee hereof, represent a significant advance in this technology. They use an architecture including a workstation which provides a monitoring and control interface for operations and maintenance staff. Control algorithms may be executed in one or more control processors (CPs), with control achieved via redundant fieldbus modules (FBMs) that connect to Field Devices (FDs), such as single or multivariable transmitters, or Programmable Logic Controllers (PLCs), and sensors or valves associated with the physical equipment to be operated. Various software packages provide historical tracking of plant data, alarming capabilities, operator action tracking, and status of all stations on the process control system network. In this regard, configurators are capable of tracking the configuration of the network, including the various devices therein, and generating messages identifying which network component may be malfunctioning or otherwise generating a fault.

While the prior art techniques have proven effective to date, the ever increasing complexity of control systems may render some of those techniques problematic. For example, due to the complexities of these systems, there are often interdependencies of how various components might fail, as there tends to be a great deal of data flow through the system, such as measurement and status information, that affect downstream calculations. A fault within the network may therefore result in a great deal of information in the form error messages from various network components. It is often time consuming and cumbersome to review these messages and their interdependencies in order to identify the root cause(s) of the particular fault(s). This may result in an entire device being marked for replacement, when the root cause may have been an easily correctable aspect of that device, or when the root cause was actually another component located logically upstream of the device registering the fault.

Thus, a need exists for an improved system and method for displaying and otherwise identifying error conditions in field devices within a process control system.

### SUMMARY

In one aspect of the invention, computer readable program code disposed on a computer readable medium is configured to store hierarchical inputs for at least one of a plurality of field devices in a control system, including upper level inputs in the form of data relating to the process under control, received from a plurality of input devices, and lower level inputs generated by the field devices using the upper level inputs, wherein the one or more lower level inputs are dependent upon one or more of the upper level inputs. The computer readable program code is also configured to maintain a record of dependencies among the hierarchical inputs, obtain a status of each of the hierarchical inputs, and transform the hierarchical inputs into a graphical status tree representation thereof, including the dependencies shown as one or more flow paths in a hierarchically downstream direction from the upper level inputs to the lower level inputs. The status of the hierarchical inputs in the graphical status tree is visually identified by applying a visual marker to ones of the inputs having a normal status, and applying other visual markers to ones of the inputs having an error status to highlight erroneous flow paths.

In another aspect of the present invention, a graphical user interface (GUI) system for field device (FD) diagnostics in a distributed process control system includes a device representation module configured to maintain a record of input devices communicably coupled to a field device, the input devices configured to generate data relating to a process under control by the process control system. An input representation module is configured to maintain a record of a inputs used by the FD, and to represent the inputs as hierarchically upper level inputs and as hierarchically lower level inputs, so that the input representation module is configured to represent the data as the upper level inputs, and to represent inputs generated by the FD as the lower level inputs, with the lower level inputs being dependent upon the upper level inputs. An input dependencies module is configured to maintain a record of dependencies among the plurality of inputs. A status module is configured to obtain from the FD, an operational status of each of the plurality of inputs. A transformation module communicably coupled to the status module is configured to transform the plurality of inputs into a graphical status tree representation thereof, including the dependencies shown as one or more flow paths in a hierarchically downstream direction from the upper level inputs to the lower level inputs. The transformation module is configured to visually identify the status of the inputs in the status tree, to apply a visual marker to ones of the plurality of inputs in the status tree having a normal status, and to apply other visual markers to inputs in the status tree having an error status, to highlight erroneous flow paths.

In yet another aspect of the invention, a method for displaying status of a field device in a distributed process control system includes maintaining, with a device representation module, a record of a plurality of input devices communicably coupled to one or more field devices in the distributed process control system, the input devices configured to generate data relating to physical aspects of a process under control by the process control system. With an input representation module, a record is maintained of hierarchical inputs used in at least one of the field devices, including upper level inputs in the form of the data, and lower level inputs generated by the field devices using the upper level inputs, in which the lower level inputs are dependent upon one or more of the upper level inputs. With an input dependencies module, a record is maintained of dependencies among the various inputs. With a status module communicably coupled to the FD, operational status of each of the plurality of inputs is maintained. A transformation module communicably coupled to the status module is used to transform the plurality of inputs into a graphical status tree representation thereof, including the dependencies shown as one or more flow paths in a hierarchically downstream direction from the upper level inputs to the lower level inputs. The transformation module also visually identifies the status of the inputs in the graphical status tree, by applying a visual marker the inputs having a normal status, and applying other visual markers inputs having an error status to highlight erroneous flow paths.

In still another aspect of the invention, a field device diagnostic system for a distributed process control system includes a field device (FD) communicably coupled to the distributed control system, and a series of input devices coupled to the FD, the input devices configured to generate data relating to the process under control by the process control system. The FD is configured to use a plurality of inputs to generate one or more outputs usable by the control system, the inputs including hierarchically upper level inputs and hierarchically lower level inputs. The FD is configured to capture and use the data as the upper level inputs, and to use the upper level inputs to generate one or more of the lower level inputs, in which the lower level input(s) are dependent upon one or more of the upper level inputs. An input dependencies module is configured to maintain a record of dependencies among the plurality of inputs, and a status module is configured to obtain, substantially in real time, a status of each of the plurality of inputs. A transformation module communicably coupled to the status module is configured to transform the inputs into a graphical status tree representation thereof, including the dependencies shown as one or more flow paths in a hierarchically downstream direction from the upper level inputs to the lower level inputs. The transformation module is configured to identify, by color-code, the status of the inputs in the status tree, to apply a color to inputs in the status tree having a normal operational status and to apply other colors to inputs having an error status, to highlight erroneous flow paths. The color applied to a hierarchically uppermost input of a particular erroneous flow path is distinct from the color applied to the other inputs within the particular erroneous flow path, so that the hierarchically uppermost input of each erroneous flow path is color coded to represent a root cause of an error, while the other inputs within each erroneous flow path are color coded to represent error conditions generated by one or more hierarchically upstream inputs. The graphical status tree is updated in real time by communication with the status module.

The features and advantages described herein are not all-inclusive and, in particular, many additional features and advantages will be apparent to one of ordinary skill in the art in view of the drawings, specification, and claims. Moreover, is should be noted that the language used in the specification has been principally selected for readability and instructional purposes, and not to limit the scope of the inventive subject matter.

### BRIEF DESCRIPTION OF THE DRAWINGS

FIGS. 1-3 are schematic diagrams of representative process control systems in which embodiments of the present invention may be employed;

FIG. 4 is a representative graphical status tree of an embodiment of the present invention; and

FIG. 5 is a view similar to that of FIG. 4, of an alternate embodiment of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

### General Overview

In a representative embodiment, the present invention includes a field device diagnostic/Graphical User Interface (GUI) system for a distributed process control system having at least one field device (FD) communicably coupled thereto. The FD may be a multivariable transmitter such as available from Invensys Systems, Inc. (Foxboro, Mass.), or may optionally be a conventional programmable logic controller (PLC). A series of input devices provide process related data to the FD. These input devices include various sensors and the like, such as those configured to detect temperature, absolute pressure, differential pressure, mass flow rate, etc., of the process under control. The FD thus receives the data from the input devices as upper level inputs, uses them to calculate lower level inputs, and then uses one or more of these various inputs to generate outputs which are then sent to the process control system, for use by other system components including a monitoring and control interface (e.g., workstation) used by operations and maintenance staff.

The diagnostic system includes a Graphical User Interface (GUI) module configured to generate a diagnostic GUI for display, e.g., on the monitoring and control interface. The GUI module includes an input dependencies module which maintains a record of the inputs used by the FD, including dependencies among the upper level and lower level inputs. A status module which is communicably coupled to the FD, obtains, substantially in real time, an operational status of each of the inputs.

A transformation module, communicably coupled to the status module, transforms the input information into a graphical status tree, including dependencies shown as one or more flow paths extending in a hierarchically downstream direction from the upper level inputs to the lower level inputs. The various inputs in the status tree are color-coded to provide a visual indication of their operational status. In this regard, the transformation module applies one color to inputs having a normal operational status, and applies other colors to inputs having an error status. This serves to visually highlight any erroneous flow paths. In addition, the color applied to a hierarchically uppermost input of a particular erroneous flow path is distinct from the color applied to the other inputs within the erroneous flow path. In this manner, the hierarchically uppermost input of each erroneous flow path is uniquely color coded to represent a root cause of an error, while the other inputs within the erroneous flow path are color coded to indicate that their error conditions were caused by one or more hierarchically upstream inputs. The transformation module communicates with the status module to update the graphical status tree in real time.

As used in this document, the term “computer” is meant to encompass a workstation, personal computer, personal digital assistant (PDA), wireless telephone, or any other suitable computing device including a processor, a computer readable medium upon which computer readable program code may be disposed, and a user interface. A “fieldbus” is a digital, two-way, multi-drop communication link among intelligent measurement and control devices, and serves as a local area network (LAN) for advanced process control, remote input/output and high speed factory automation applications. Terms such as “component,” “module”, “control components/devices,” “messenger component or service,” and the like are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server (or control related devices) can be components. One or more components may reside within a process and/or thread of execution and a component may be localized on one computer and/or distributed between two or more computers or control devices. In another example, a messenger component can be a process executable on a computer or control device to process PLC interactions in accordance with an application that interfaces to a PLC that may alter one or more characteristics of PLC operations. The term “real time” refers to sensing and responding to external events nearly simultaneously (e.g., within seconds, milliseconds or microseconds) with their occurrence, or sufficiently fast to enable the device to keep up with an external process (for example, sufficiently fast as to avoid losing data generated by the FDs).

### Programming Languages

The system and method embodying the present invention can be programmed in any suitable language and technology, such as, Hypertext Markup Language (HTML), Active ServerPages (ASP) and Javascript. Alternative versions maybe developed using other programming languages including, but not limited to: C++; Visual Basic; Java; VBScript; Jscript; BCMAscript; DHTM1; XML and CGI. Any suitable database technology can be employed, but not limited to: Microsoft Access and IBM AS 400.

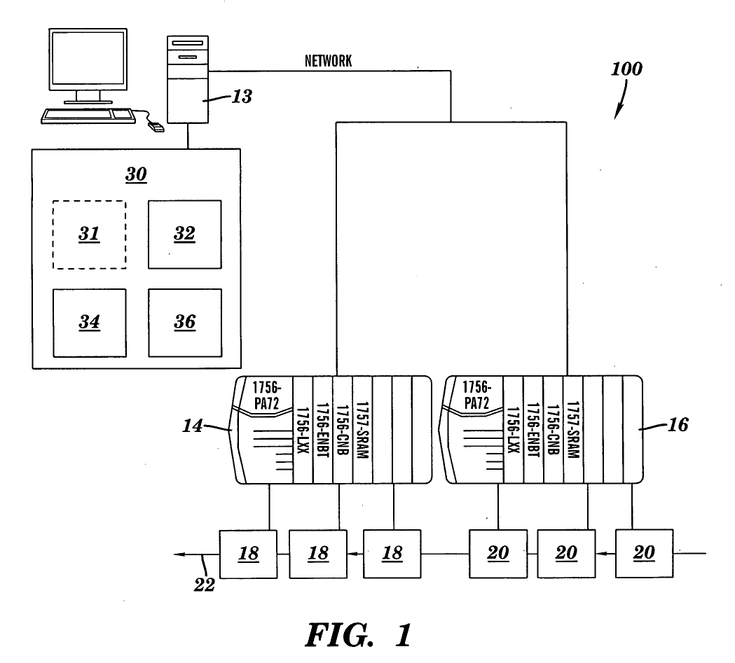

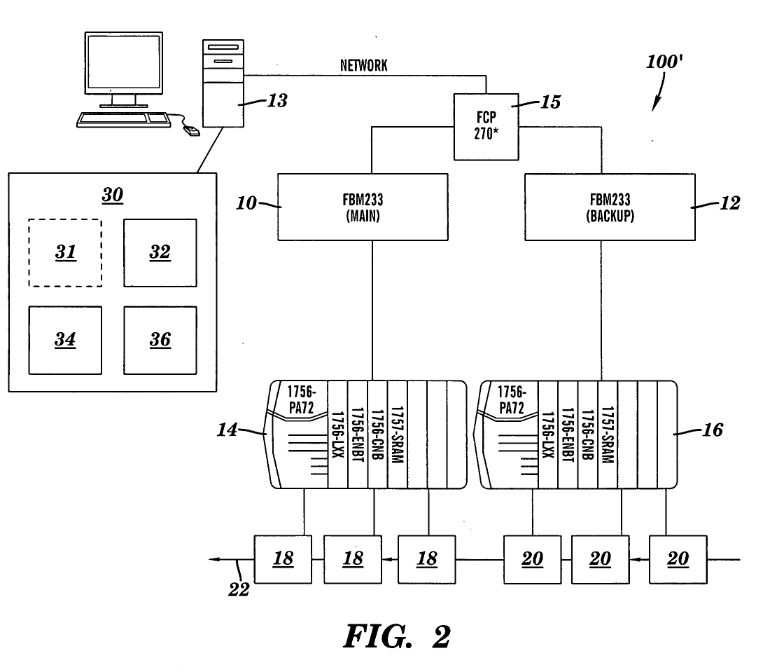

Referring now to the Figures, embodiments of the present invention will be more thoroughly described. Turning to FIG. 1, representative embodiments of the present invention include a field device diagnostic system that may be incorporated within a distributed control system such as that shown at 100. Field devices (FDs) 14, 16 capture data generated by various input devices (e.g., sensors) 18, 20, associated with the physical equipment (e.g., process) 22. The FDs use the captured data as high level inputs, which the FD may then use to generate lower level inputs. One or more of these various inputs may be used to generate outputs which are sent to other devices within the process control system, including one or more monitoring and control interfaces (e.g., workstations) 13. Various conventional control algorithms may be executed in workstation 13, and/or optionally, in one or more control processors (CPs) 15 (FIG. 2), communicably coupled to field bus modules (FBMs) 10, 12 (FIG. 2) to achieve control via the FDs 14, 16, and input devices 18, 20.

In particular embodiments, the FD may be a multivariable transmitter such as available from Invensys Systems, Inc. (Foxboro, Mass.) or a conventional programmable logic controller. A series of input devices 18,20 provide process related data to the FDs 14, 16. These input devices include various sensors and the like, such as temperature, absolute pressure, differential pressure, mass flow rate sensors, etc., which are coupled to the process 22. The FDs thus receives the data from the input devices as upper level inputs, such as absolute pressure, differential, and temperature, and use them to calculate lower level inputs (e.g., measurements using the higher level inputs). The FDs may then use one or more of the various inputs to generate outputs (such as measurements which represent a combination of inputs) which are sent to the process control system including workstation 13.

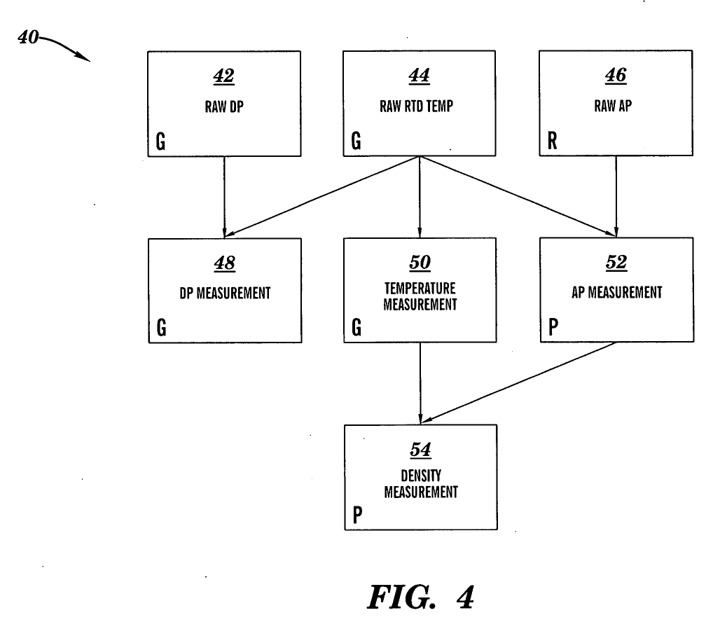

As shown, an embodiment of the field device diagnostic system (Graphical User Interface system) includes a Graphical User Interface (GUI) module 30 configured to generate a diagnostic GUI which includes a graphical status tree 40 (FIG. 4) for display, e.g., by the monitoring and control interface (workstation) 13. The GUI module 30 optionally includes a device representation module 31 (shown in phantom) configured to maintain a record of input devices, such as various sensors 18, 20, communicably coupled to an FD 14, 16. Module 30 includes an input dependencies module 32 which maintains a record of the inputs used by the FD, including dependencies among the upper level and lower level inputs. The dependencies module 32 thus stores hierarchical inputs for the FDs, including upper level inputs in the form of data relating to the process under control, received from a plurality of input devices 18, 20. Module 32 also maintains a record of lower level inputs generated by the FDs using the upper level inputs, i.e., lower level inputs which are dependent upon one or more of the upper level inputs, as will be discussed in greater detail hereinbelow with respect to FIG. 4. A status module 34 which is communicably coupled to the FD (14, 16) via system 100 obtains, substantially in real time, a status of each of the inputs.

A transformation module 36, which is communicably coupled to the status module 34, generates a graphical status tree (GUI) 40 (FIG. 4) of the inputs, including dependencies, shown as one or more flow paths in a hierarchically downstream direction from the upper level inputs to the lower level inputs. Graphical Status Tree (GUI) 40 is provided with visual indicators, such as color-coding, to facilitate diagnostic trouble-shooting, as will be discussed in greater detail hereinbelow with respect to FIG. 4. The GUI module 30, including transformation module 36, communicates with the status module 34 to update the graphical status tree in real time.

It should be noted that embodiments of the present invention may include GUI module 30 itself, or may also include one or more of the various components of system 100, such as an FD 14, 16.

Turning now to FIG. 2, embodiments of the present invention may be employed within a system 100′, which includes various devices commonly used in industrial process control systems. For example, in the embodiment shown, system 100′ may includes one or more control processors (CPs) 15, which are configured to execute various control algorithms, and which are communicably coupled to field bus modules (FBMs) 10, 12 to achieve control of process 22 via the FDs 14, 16 and input devices 18, 20. System 100′ may thus include an I/A SERIES® process control system, with CP 15 including an FCP 270 or ZCP Control Processor available from Invensys Systems, Inc., Foxboro, Mass., (“Invensys”). The FBMs 10, 12 may be conventional FBM 233 control processors, also available from Invensys, with control room workstation 13 running, for example, a PC50 configurator, also from Invensys, which is modified in accordance with the teachings of the present invention to include GUI module 30.

In representative embodiments, the FDs 14, 16 include multivariable transmitters, such as an IMV31 transmitter (Invensys). The FDs 14, 16 may also include programmable logic controllers (PLCs). These FDs may be communicably coupled to any number of sensors 18, 20 associated with a process 22 (such as to measure flow through a conduit). As a non-limiting example, the FDs may be ControlLogix™ Programmable Logic Controllers (PLCs) by Allen-Bradley Company, Inc. (Rockwell International). (Suitable PLCs may also be available from Telvent Git, S.A.)

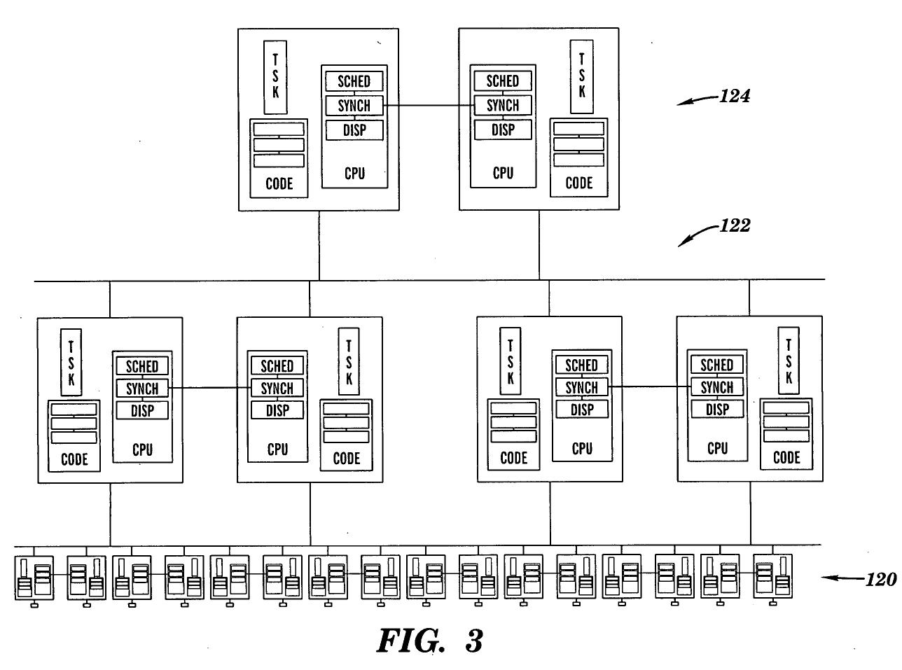

Moreover, although the foregoing embodiments have been shown and described as having a single pair of FBMs 10, 12 and FDs 14, 16, it should be recognized that aspects of the present invention may be applied to process control systems and apparatus of substantially any number of components. For example, embodiments of the present invention may be employed within a process control system having large numbers of FDs 120, FBMs 122 and CPs 124 is illustrated in FIG. 3.

Turning now to FIG. 4, aspects of an exemplary graphical status tree (GUI) 40 generated by GUI module 30 (FIGS. 1, 2) is described. As mentioned hereinabove, an exemplary FD 14, 16 may include a multivariable pressure transmitter which receives data from input devices 18, 20. In this example, an FD 14 receives data from input devices 18 in the form of a differential pressure (DP) sensor, a resistive temperature detector (RTD), and an absolute pressure (AP) sensor. The raw data provided by these input devices is captured by the FD 14, and GUI module 30 transforms them into graphically represented upper level inputs 42, 44, and 46, respectively, of status tree 40. As also shown graphically in tree 40, these upper level inputs are combined by the FD 14 in various ways to generate lower level inputs shown as DP Measurement 48, Temperature Measurement 50, AP Measurement 52, and Density Measurement 54. In this regard, status tree 40 provides a visual indication of these combinations (i.e., dependencies) by the use of arrows depicting downstream information flow from hierarchically upper level inputs to hierarchically lower level inputs. In this example, DP measurement 48 is shown as being dependent on (i.e., as using a combination of both) Raw DP 42 and Raw RTD Temp 44. Temperature Measurement 50 is shown as dependent upon Raw RTD Temp 44. AP Measurement 52 is shown as dependent upon both Raw RTD Temp 44 and Raw AP 46. Density Measurement 54 is shown as being dependent on both Temperature Measurement 50 and AP Measurement 52.

It should be noted that Status Tree 40 is merely exemplary, and that many actual FDs may include substantially any number of inputs, including both raw and calculated measurements of various types. Additional examples include volumetric flow or mass flow, depending on the particular application. It should therefore be further recognized that the particular Status Tree will depend on the particular FD being used, and on how the particular FD has been configured in the field. In this regard, it is to be expected that some of the capabilities of a particular Field Device may or may not be used, and/or may be configured in distinct manners, so that even FDs of the same make and model may have mutually distinct Status Trees 40, etc. It also be noted that any one or more of the various inputs associated with an FD may be outputted by the FD to the process control system for use thereby. For example, with reference to FIG. 4, any of the lower level inputs 48-54 may be outputted to the process control system 100, 100′.

Referring back to FIG. 4, an aspect of Status Tree 40 includes the visual presentation of any error conditions, to visually highlight the portions of the tree that are in failure. Moreover, this visual presentation is configured to visually distinguish root failure(s) from collateral failures, i.e., to visually distinguish upstream failures from downstream failures caused by those upstream failures.

In particular embodiments, the visual indication of the inputs provided by the Status Tree (GUI) may include substantially any type of visual indication, such as color-coding, shading, cross-hatching, flashing, changing the shape of the inputs, applying symbols (alphanumeric or otherwise) etc., or combinations thereof. In the embodiment shown, the various inputs in the status tree are color-coded to provide a visual indication of their operational status. In this regard, the transformation module applies one color (e.g., Green, as indicated with “G”) to inputs having a normal operational status, and applies other colors (e.g., Pink “P” and Red “R”) to inputs having an error status. The pink and red inputs thus serves to visually highlight any erroneous flow paths. Moreover, the color (e.g., Red) applied to a hierarchically uppermost input of a particular erroneous flow path is distinct from the color (e.g., Pink) applied to the other inputs within the erroneous flow path. In this manner, as shown, the hierarchically uppermost input of an erroneous flow path is uniquely color coded (e.g., Red) to represent a root cause of an error, while the other inputs within the erroneous flow path are color coded (e.g., Pink) to indicate that their error conditions were caused by one or more hierarchically upstream input. It should also be noted that in particular embodiments, the graphical status tree is updated in real time by substantially real time communication of the status module 34 with the transformation module 36. It should be recognized that substantially any colors may be used for the color-coding discussed herein.

In the exemplary GUI 40 shown, Raw DP 42, Raw RTD 44, DP Measurement 48 and Temperature Measurement 50 are all green. However, Raw AP 46 is red while AP Measurement 52 and Density Measurement are both pink. So while prior art devices/systems may simply register a Density Measurement error, a user viewing GUI 40 can readily ascertain by this visual indication that there is a density error at 54, but that it was caused by an AP Measurement error at 52, which in turn, can be traced back to a Raw AP error at 46. Thus, the visual indication provided by GUI 40 enables a user to quickly determine the root cause of the various errors without having to read a lot of error messages. It should be noted, however, that in particular embodiments, the user may click on the various inputs to drill down to obtain additional information regarding the errors. For example, a user may click (using a computer mouse or other input device) or otherwise actuate Raw AP 46 to obtain additional details regarding the error. In this regard, by clicking on the input, the user may determine whether the error was generated by the AP sensor itself, or by a configuration error such as by the selection of incorrect measurement units or operating ranges.

Alternatively, if, referring to this example, Raw AP 46 was green, then AP measurement 52 would be red, indicating that the root cause of the error resided at AP Measurement 52. This would indicate that there was not a problem with the Raw AP 46, but rather, the problem was related to the calculation of the AP Measurement. And, by clicking on this input, the user may obtain more detailed information regarding the error. For example, upon clicking the input, the user may see that this particular input was misconfigured, such as by using incorrect units or ranges.

It should be noted that although GUI module 30 is shown as running (and displaying GUI 40) on workstation 13 (FIGS. 1, 2), it may run on substantially any computer communicably coupled to a particular FD 14, 16, including a handheld computer (e.g., configurator) coupled directly to the FD. Alternatively, GUI module 30 may run on any number of other components of network 100, 100′, including control processor 15 or the FD itself, with the GUI 40 being displayed on that component, or on substantially any other component communicably coupled thereto, having a screen or other suitable display capabilities.

In particular embodiments, GUI module 30 is incorporated into otherwise conventional FD configuration software. This tends to facilitate population of dependencies module 32, since the information need by module 32 is obtained by the configurator as part of the conventional FD configuration process. Thus, once FD configuration is complete, the configuration software may simply pass the information regarding the various inputs and their dependencies to the dependencies module 32. Alternatively, e.g., in the event GUI Module 30 is not integrated or otherwise communicably coupled to the configurator, module 30 may simply tunnel through the control system network to communicate with the individual FDs to obtain the requisite input and dependency information.

This communication, e.g., either via the configurator or by direct tunneling, may also be used by the status module 34 to effect real time updates on the status of the various inputs. In this regard, it should be noted that status module 34 is configured to capture conventional text-based error messages of the type commonly provided by various FDs known to those skilled in the art. These conventional error messages are thus transformed by module 36 into the aforementioned visual indicators of GUI 40, etc.

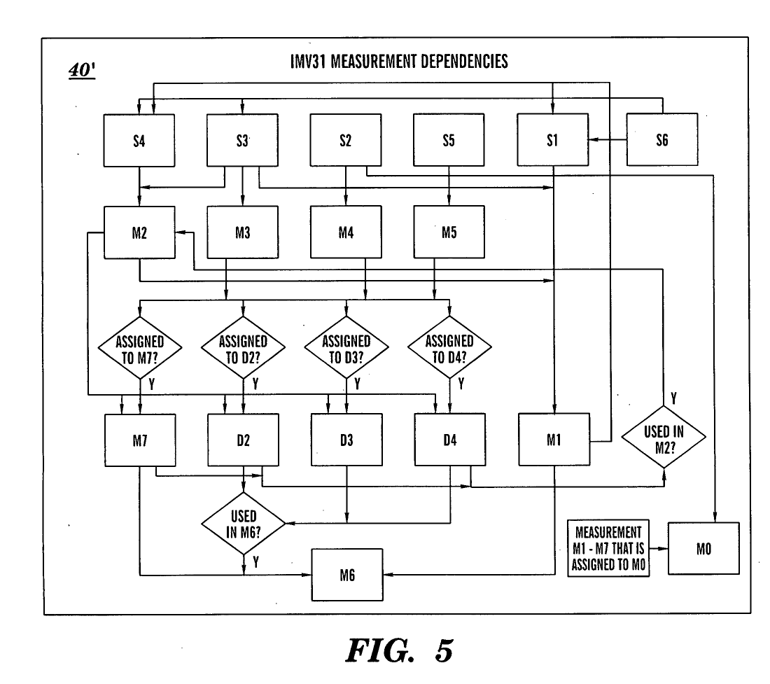

An alternate embodiment of a GUI in accordance with the teachings of the present invention is shown as 40′ in FIG. 5. This GUI 40′ is generated by GUI module 30 (FIGS. 1, 2), and displays a visual transformation of various inputs of an I/A SERIES® Multivariable Transmitter Model IMV31 conventional IMV31™ FD commercially available from Invensys. Upper level inputs are shown at S1-S6, with lower level inputs shown at M0-M7, and D1-D4.

Referring now to the following Table I, a method of interfacing redundant devices to a distributed control system, in accordance with the present invention, is shown and described.

TABLE I

| | |
|---|---|
| 200 | Maintain a record of the input devices communicably coupled to |
| | one or more FDs in a process control system |
| 202 | Maintain a record of hierarchical inputs used in the field devices |
| 204 | Maintain a record of dependencies among the inputs |
| 206 | Obtain the operational status of the inputs, substantially in real time |
| 208 | Transform the inputs into a graphical status tree representation |
| 210 | Visually identify the status of the inputs in the graphical status tree |

At 200, device representation module 32 maintains a record of the input devices communicably coupled to one or more FDs in a process control system, the input devices configured to generate data relating to physical aspects of a process under control by the process control system. At 202, input representation module 34 maintains a record of hierarchical inputs used in the field devices, including the upper and lower level inputs. At 204, an input dependencies module maintains a record of dependencies among the inputs. At 206, a status module communicably coupled to the FD obtains the operational status of the inputs, substantially in real time. At 208, the transformation module transforms the inputs into a graphical status tree representation thereof. At 210, the transformation module visually identifies the status of the inputs in the graphical status tree, by applying a visual marker to inputs having a normal status, and applying other visual markers to inputs having an error status, to highlight erroneous flow paths.

Optional aspects of this method are shown and described with respect to Table II.

TABLE II

| | |
|---|---|
| 212 | Apply a visual marker to a hierarchically uppermost |
| | input of a particular erroneous flow path, which is |
| | visually distinct from other inputs of the flow path |
| 214 | Apply color codes to the inputs |
| 216 | Update the graphical status tree in real time |
| 218 | Configure FD to be couplable to the control system, |
| | and to use the inputs to generate one or more outputs |
| 220 | Configure FD to receive data from input devices |
| 222 | Configure FD to use the data as upper level inputs, and |
| | to use the upper level inputs to generate lower level inputs. |

At 212, the transformation module marks a hierarchically uppermost input of a particular erroneous flow path with a visual marker which is distinct from those applied to the other inputs within that erroneous flow path. At 214, the visual markers applied by the transformation module are color codes. At 216, the graphical status tree is updated substantially in real time. At 218, the FD is configured to be couplable to the distributed control system, and to use the plurality of inputs to generate one or more outputs usable by the control system. At 220, the FD is configuring to receive data from the input devices. At 222, the FD is configured to capture and use the data as upper level inputs, and to use the upper level inputs to generate the lower level inputs.

Furthermore, embodiments of the present invention include a computer program code-based product, which includes a computer readable storage medium having program code stored therein which can be used to instruct a computer to perform any of the functions, methods and/or modules associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be understood that any of the features described with respect to one of the embodiments described herein may be similarly applied to any of the other embodiments described herein without departing from the scope of the present invention.

Although various embodiments have been discussed herein as being capable of functioning substantially in real time, it should be recognized that these embodiments may also function using historical data without departing from the scope of the invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

For example, the present invention should not be limited by the number of upper level inputs, lower level inputs, input devices (e.g., sensors) and/or field devices. Moreover, the various embodiments shown and described herein may be implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. An article of manufacture comprising:
computer readable program code disposed on a computer readable medium, the computer readable program code configured to:
store hierarchical inputs for at least one of a plurality of field devices in a control system, including upper level inputs in the form of data relating to the process under control, received from a plurality of input devices, and lower level inputs generated by the field devices using the upper level inputs, wherein the one or more lower level inputs are dependent upon one or more of the upper level inputs;
maintain a record of dependencies among said hierarchical inputs;
obtain a status of each of said hierarchical inputs;
transform said hierarchical inputs into a graphical status tree representation thereof, including said dependencies shown as one or more flow paths in a hierarchically downstream direction from said upper level inputs to said lower level inputs;
visually identify the status of the hierarchical inputs in the graphical status tree, by applying a visual marker to ones of said inputs having a normal status, applying other visual markers to ones of said inputs having an error status to highlight erroneous flow paths.

2. The article of claim 1, wherein said computer readable program code is configured to apply another color to a hierarchically uppermost input of a particular erroneous flow path, which is distinct from the other color applied to other inputs within the particular erroneous flow path.

3. The article of claim 1, wherein said computer readable program code is configured to mark a hierarchically uppermost input of each erroneous flow path to represent a root cause of an error, and to mark the other inputs within each erroneous flow path to represent error conditions generated by one or more hierarchically upstream inputs.

4. The article of claim 1, wherein said computer readable program code is configured to update said graphical status tree representation substantially in real time.

5. The article of manufacture of claim 1, wherein said computer readable media and said computer readable program code are incorporated into a configuration and calibration system running on a computer communicably coupled to the at least one field device.

6. The article of manufacture of claim 5, wherein said computer comprises a control room workstation of a process control system.

7. The article of manufacture of claim 5, wherein said computer readable program code is incorporated into a PC communicably coupled to said at least one field device.

8. The article of manufacture of claim 1, wherein the at least one field device comprises a transmitter.

9. The article of manufacture of claim 1, wherein the computer readable program code is configured to capture error conditions of the inputs substantially in real time.

10. A graphical user interface (GUI) system for field device (FD) diagnostics in a distributed process control system, the GUI comprising:
a device representation module configured to maintain a record of input devices communicably coupled to a field device, the input devices configured to generate data relating to a process under control by the process control system;
an input representation module configured to maintain a record of a plurality of inputs used by the FD, and to represent the inputs as hierarchically upper level inputs and as hierarchically lower level inputs, wherein said input representation module is configured to represent said data as the upper level inputs, and to represent inputs generated by the FD as the lower level inputs, wherein the lower level inputs are dependent upon the upper level inputs;
an input dependencies module configured to maintain a record of dependencies among said plurality of inputs;
a status module configured to obtain from the FD, an operational status of each of said plurality of inputs;
a transformation module communicably coupled to said status module, configured to transform said plurality of inputs into a graphical status tree representation thereof, including said dependencies shown as one or more flow paths in a hierarchically downstream direction from said upper level inputs to said lower level inputs;
the transformation module configured to visually identify the status of said inputs in the status tree;
the transformation module configured to apply a visual marker to ones of said plurality of inputs in the status tree having a normal status;
the transformation module configured to apply other visual markers to ones of said plurality of inputs in the status tree having an error status, to highlight erroneous flow paths.

11. The GUI system of claim 10, wherein said transformation module is configured to apply one of said other visual markers to a hierarchically uppermost input of a particular erroneous flow path, and to apply another of said other visual markers to the other inputs within the particular erroneous flow path, so that the one of the said other visual markers is visually distinct from the other of said visual markers.

12. The GUI system of claim 10, wherein said transformation module is configured to mark a hierarchically uppermost input of each erroneous flow path to represent a root cause of an error, while the other inputs within each erroneous flow path are marked to represent error conditions generated by one or more hierarchically upstream inputs.

13. The GUI system of claim 10, wherein said graphical status tree is configured for being updated substantially in real time by communication between said transformation module and said status module.

14. The GUI system of claim 10, wherein said transformation module is configured to identify the status of inputs by color-code.

15. The GUI system of claim 14, wherein said transformation module is configured to apply a color to ones of said plurality of inputs having a normal status.

16. The GUI system of claim 15, wherein said transformation module is configured to apply other colors to ones of said plurality of inputs in the status tree having an error status, to highlight erroneous flow paths, wherein one of said other colors applied to a hierarchically uppermost input of a particular erroneous flow path is distinct from an other of said other colors applied to the other inputs within the particular erroneous flow path;
wherein said hierarchically uppermost input of each erroneous flow path is marked to represent a root cause of an error, while the other inputs within each erroneous flow path are marked to represent error conditions generated by one or more hierarchically upstream inputs; and
wherein said graphical status tree is updated substantially in real time by communication between said transformation module and said status module.

17. The GUI system of claim 10, disposed within a diagnostic system of the distributed process control system, the diagnostic system comprising the FD communicably coupled to the distributed control system.

18. The GUI system of claim 10, wherein said input dependencies module, said status module, and said display module, comprise computer readable program code disposed on a computer readable medium.

19. The GUI system of claim 18, wherein said computer readable program code is incorporated into a configuration and calibration system running on a computer communicably coupled to the field device.

20. The GUI system of claim 19, wherein said computer comprises a workstation coupled to said process control system.

21. The GUI system of claim 20, wherein said computer comprises a control processor of said process control system.

22. The GUI system of claim 19, wherein said computer comprises a handheld computer coupled directly to said field device.

23. The GUI system of claim 10, wherein said field device comprises a transmitter.

24. The GUI system of claim 10, wherein said status module is configured to capture error conditions of the inputs substantially in real time.

25. A method for displaying status of a field device in a distributed process control system,
the method comprising:
(a) maintaining, with a device representation module, a record of a plurality of input devices communicably coupled to one or more field devices in the distributed process control system, the input devices configured to generate data relating to physical aspects of a process under control by the process control system;
(b) maintaining, with an input representation module, a record of hierarchical inputs used in at least one of the field devices, including upper level inputs in the form of said data, and lower level inputs generated by the field devices using the upper level inputs, wherein the one or more lower level inputs are dependent upon one or more of the upper level inputs;
(c) maintaining, with an input dependencies module, a record of dependencies among said plurality of inputs;
(d) obtaining, with a status module communicably coupled to the FD, operational status of each of said plurality of inputs;
(e) transforming, with a transformation module communicably coupled to said status module, said plurality of inputs into a graphical status tree representation thereof, including said dependencies shown as one or more flow paths in a hierarchically downstream direction from said upper level inputs to said lower level inputs; and
(f) visually identifying, with the transformation module, the status of the inputs in the graphical status tree, by applying a visual marker to ones of said plurality of inputs having a normal status, and applying other visual markers to ones of said plurality of inputs having an error status to highlight erroneous flow paths.

26. The method of claim 25, wherein said visually identifying (f) comprises applying, with the transformation module, one of said other visual markers to a hierarchically uppermost input of a particular erroneous flow path, and to apply another of said other visual markers to the other inputs within the particular erroneous flow path, so that the one of the said other visual markers is visually distinct from the other of said visual markers, wherein a hierarchically uppermost input of each erroneous flow path is visually marked to represent a root cause of an error, while the other inputs within each erroneous flow path are visually marked to represent error conditions generated by one or more hierarchically upstream inputs.

27. The method of claim 26, wherein said visually identifying (f) comprises applying a color code to ones of said plurality of inputs having a normal status, and applying other color codes to ones of said plurality of inputs having an error status to highlight erroneous flow paths.

28. The method of claim 27, wherein the other color applied to a hierarchically uppermost input of a particular erroneous flow path is distinct from the other color applied to other inputs within the particular erroneous flow path, so that the hierarchically uppermost input of each erroneous flow path is color coded to represent a root cause of an error, while the other inputs within each erroneous flow path are color coded to represent error conditions generated by one or more hierarchically upstream inputs.

29. The method of claim 28, comprising updating the graphical status tree substantially in real time.

30. The method of claim 25, further comprising:
(f) configuring a field device (FD) to be couplable to the distributed control system, and to use a plurality of inputs to generate one or more outputs usable by the control system, the plurality of inputs including hierarchically upper level inputs and hierarchically lower level inputs;
(g) configuring the FD to receive, from a plurality of input devices, data relating to the process under control;
(h) configuring the FD to capture and use said data as said upper level inputs, and to use the upper level inputs to generate one or more of the lower level inputs, wherein the one or more lower level inputs are dependent upon one or more of the upper level inputs.

31. A field device diagnostic system for a distributed process control system, the field device diagnosis system comprising:
a field device (FD) communicably coupled to the distributed control system;
a plurality of input devices coupled to the FD, said input devices configured to generate data relating to the process under control by the process control system;
said FD configured to use a plurality of inputs to generate one or more outputs usable by the control system, said plurality of inputs including hierarchically upper level inputs and hierarchically lower level inputs;
said FD configured to capture and use said data as said upper level inputs;
said FD configured to use said upper level inputs to generate one or more of said lower level inputs, wherein said one or more lower level inputs are dependent upon one or more of said upper level inputs;
an input dependencies module configured to maintain a record of dependencies among said plurality of inputs;
a status module configured to obtain, substantially in real time, a status of each of said plurality of inputs;
a transformation module communicably coupled to said status module, and configured to transform the plurality of inputs into a graphical status tree representation thereof, including said dependencies shown as one or more flow paths in a hierarchically downstream direction from said upper level inputs to said lower level inputs;
the transformation module configured to identify, by color-code, the status of said inputs in the status tree;
the transformation module configured to apply a color to ones of said plurality of inputs in the status tree having a normal operational status;
the transformation module configured to apply other colors to ones of said plurality of inputs having an error status, to highlight erroneous flow paths, the other color applied to a hierarchically uppermost input of a particular erroneous flow path being distinct from the other color applied to the other inputs within said particular erroneous flow path;
wherein said hierarchically uppermost input of each erroneous flow path is color coded to represent a root cause of an error, while the other inputs within each erroneous flow path are color coded to represent error conditions generated by one or more hierarchically upstream inputs; and
wherein said graphical status tree is updated in real time by communication with said status module.
